(19) United States
(12) Patent Application Publication
(10) Pub. No.: US 2009/0161564 A1
(43) Pub. Date: Jun. 25, 2009

(54) TRANSMISSION APPARATUS AND ALARM CONTROL METHOD

(75) Inventors: Tomoyuki Yamamoto, Kawasaki (JP); Masakazu Bamba, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/339,704

(22) Filed: Dec. 19, 2008

(30) Foreign Application Priority Data
Dec. 20, 2007 (JP) 2007-328815

(51) Int. Cl. G06F 11/30

(52) U.S. Cl. 370/248

(57) ABSTRACT

A transmission apparatus having a function of establishing a connection of a path that is a signal communications channel in a communications network includes a masking part configured to mask an alarm detected after the connection of the path is established in the transmission apparatus; an alarm status detection part configured to detect a change in the status of the alarm; and an unmasking part configured to unmask the alarm masked by the masking part in response to the alarm status detection part detecting the change in the status of the alarm.

This application is based upon and claims the benefit of priority of the prior Japanese Patent Application No. 2007-328815, filed on Dec. 20, 2007, the entire contents of which are incorporated herein by reference.

### BACKGROUND

1. Field

The present invention relates to the technique of controlling an unnecessary alarm output from a transmission apparatus (hereinafter referred to as “node”) in constructing a signal communications channel (hereinafter referred to as “path”) in a communications network having multiple nodes.

2. Description of the Related Art

In setting up a path in a communications network having multiple nodes, it is sometimes the case that a node that has already completed path connecting keeps on transmitting a specific path alarm to a monitoring apparatus that monitors the nodes until the path setup is completed in the entire communications network (that is, all the nodes).

A description is given of this phenomenon with reference to FIG. 1, taking the case of setting up a path by RSVP (Resource Reservation Protocol) signaling in GMPLS (Generalized Multi-Protocol Label Switching) as an example.

FIG. 1 is a diagram showing a signaling sequence for a path setup in a communications network having Node A, Node B, Node C, and Node D. In this specification, setting up cross-connection in a node is referred to as “path connecting” and constructing the entire path is referred to as “path setup.”

Referring to FIG. 1, based on a user's request for setting up a path from the input-side port A-X of Node A to the output-side port D-Y of Node D, messages for the path setup are transmitted and received so that the path is set up.

Referring to FIG. 1, in response to the inputting of the user's request to Node A, Node A transmits a pass message (indicated as Path MSG in FIG. 1) that checks the availability of a band toward Node B (step Si). In FIG. 1, in the rectangular frame shown in correlation with each node, the RSVP message transmitted by the node (top block), the status of path connection in the node (middle block), and information on a channel (band) (bottom block) are shown. Underlining in the block indicates a change from the previous status. For example, a rectangular frame 1 of Node A shows that Node A has transmitted a pass message, that there is no path connection, and that a No. 4 port in the direction of the connection destination of Node A is available.

Each intervening (intermediate) node receiving the pass message checks channel availability, and sends the pass message to the next node if there is an available channel (steps S2 and S3). If channels are available for all the requested bands through terminal (end-point) Node D, Node D actually performs path connecting (cross-connecting), and transmits a reservation message (Resv MSG) to Node C on the start (start-point) node side (step S4). A second rectangular frame 2 corresponding to Node D shows that the input-side port D-7 and the output-side port D-Y of Node D have been connected. Further, it is shown by a bold solid line 3 that the path (user data path) between Node C and Node D has been established. The other bold solid lines also show the establishment of a path (user data path).

Each intervening (intermediate) node receiving the reservation message performs path connecting in response to the reservation message as a trigger, and sends the reservation message to the next node (steps S5 and S6). Start Node A performs path connecting in response to reception of the reservation message as a trigger. As a result of the path connecting in Node A, user data flow on the path connecting Node A through Node D.

Having performed path connecting, Node A transmits a reservation confirmation message (ResvConf MSG) indicating completion of path connecting in each node to Node B. Each intervening node receiving the reservation confirmation message sends the reservation confirmation message to the next node (steps S8 and S9). Signaling as RSVP is completed when terminal Node D receives the reservation confirmation message. However, transmission of the reservation confirmation message is an optional function.

If no user data are transmitted on the path, that is, if no user data are mapped onto the path although an input-side port and an output-side port are connected (cross-connection is established) in a certain node, the node outputs an unequipped payload (UNEQ-P) alarm, which is a path alarm indicating that condition.

The UNEQ-P alarm is determined by C2 byte of a path overhead (POH) in a synchronous digital communications network. If C2 byte is 00h, it is determined to be a UNEQ-P alarm.

A description is given, with reference to FIG. 2, of the mechanism of issuing the UNEQ-P alarm.

FIG. 2 is a diagram showing a node where there is no path connection (cross-connection) between a port A-X and a port A-4 while there is a path connection between a port A-1 and a port A-5 and user data are received at each of the port A-X and the port A-1.

At this point, a UNEQ-P alarm is issued from the output-side port A-4 with no path connection to a downstream node. No UNEQ-P alarm is issued from the output-side port A-5 receiving the user data.

Next, a description is given, with reference to FIG. 3, of the mechanism of detecting the UNEQ-P alarm.

FIG. 3 is a diagram showing that there is a path connection only in Node Z among Node X, Node Y, and Node Z. Since no user data are received at the output-side port of Node X, a UNEQ-P alarm is issued therefrom. The UNEQ-P alarm is received at Node Y. However, since no path connection has been established in Node Y, the UNEQ-P alarm is not monitored inside Node Y. Another UNEQ-P alarm is issued from the output-side port of Node Y.

Since there is a path connection in Node Z, the UNEQ-P alarm on the path is monitored. Accordingly, the UNEQ-P alarm issued from Node Y is detected by the monitoring in Node Z to be transmitted (reported) outside.

In the procedure illustrated in FIG. 1, no user data have been transmitted when Node D receives the path message because the entire path has not been established. Accordingly, Node D outputs a UNEQ-P alarm until the entire path is established after receiving the path message and performing path connecting. Likewise, Node C and Node B also output respective UNEQ-P alarms until the entire path is established after internally performing path connecting.

Further, FIG. 1 shows setting up a path using an RSVP signaling message. Alternatively, it is also possible to set up a path by the user inputting a command for path connecting to each node from a monitoring apparatus. In this case also, a UNEQ-P alarm may be output while setting up a path for the same reasons as described above.

This UNEQ-P alarm is cleared after completion of the path setup. Accordingly, it may not be necessary for a network administrator to monitor the UNEQ-P alarm until completion of the path setup. However, it is not easy for the network administrator to instantaneously determine whether a path alarm that has been suddenly generated is due to a path setup operation or due to actual occurrence of a failure on the network.

Further, in signaling using GMPLS or the like, a UNEQ-P alarm may be generated at a node that the network administrator is aware of based on an operation at a node that the network administrator is not aware of. In this case, it is difficult to determine whether the UNEQ-P alarm is due to a path setup operation.

Further, in the case of setting up a path by a user's operation such as inputting a command, it is also the case that the network administrator is not necessarily aware that the path is being set up by the user's operation. Therefore, it is sometimes difficult to determine whether a path alarm that has been suddenly generated is due to a path setup operation or due to actual occurrence of a failure on the network.

Therefore, in signaling using GMPLS or the like, it has been desired to mask a path alarm such as a UNEQ-P alarm output during the period between the start and completion of the path setup. Masking an alarm is to prevent the alarm from being output to the outside of a node (such as a monitoring apparatus connected to the node) even if the alarm has been detected by monitoring inside the node.

Reference may be made to Japanese Laid-Open Patent Application No. 2004-247943 for a related conventional technique.

In order to mask the unnecessary UNEQ-P alarm as described above, the UNEQ-P alarm is masked at the time of completion of path connecting in a node, and the UNEQ-P alarm is unmasked after completion of setting up the entire path. The UNEQ-P alarm may be unmasked by the following systems.

First System

A first system uses a reservation confirmation message. FIG. 4 shows a path setup sequence according to the first system.

Referring to FIG. 4, compared with FIG. 1, the masking status of the UNEQ-P alarm (the fourth block from the top) and the monitoring status of the UNEQ-P alarm (the fifth block from the top) are added to each of the rectangular frames corresponding to the nodes. The masking status of the UNEQ-P alarm indicates whether the UNEQ-P alarm is masked (ON) or not (OFF). The monitoring status of the UNEQ-P alarm indicates whether the UNEQ-P alarm is monitored and detected in the node.

As illustrated in FIG. 4, at the stage of transmitting a path message (steps S11 through S13) no path connection has been made so that the UNEQ-P alarm is not monitored in any node. Further, masking is OFF.

Then, path connecting is performed in the nodes in response to the path message of step S13 and the reservation messages of steps S14 through S16 as triggers. In response to this as a trigger, the masking of the UNEQ-P alarm is started. For example, Node D detects a UNEQ-P alarm by performing internal monitoring after having its input-side port D-7 and output-side port D-Y connected after receiving the path message in step S13. However, since the masking is turned ON, the UNEQ-P alarm is prevented from being output outside.

A reservation confirmation message (ResvConf MSG) for reporting completion of a path setup in the entire network is transmitted from Node A (step S17), so that each of Nodes B through D cancels the masking of the UNEQ-P alarm in response to reception of the reservation confirmation message as a trigger.

In FIG. 4, each of one-dot chain lines 5, 7, and 9 indicates the period from when the path connection is established and the masking is started to when the masking is canceled in response to reception of the reservation confirmation message. Further, each of dotted lines 6, 8, and 10 indicates the period for which the UNEQ-P alarm is generated. In FIG. 4, the lines 5 and 6 corresponding to Node B show that the UNEQ-P alarm is unmasked after passage of a little time since its clearance. The same applies to Nodes C and D.

However, according to E-NNI (External Network-to-Network Interface) provided by OIF/IETF, which is a standards body, the reservation confirmation message (ResvConf MSG) is an optional sequence. Therefore, some of the nodes constituting the network may not transmit this reservation confirmation message. In this case, according to such an unmasking system as the first system, where the reservation confirmation message is used as a trigger, there may be some nodes where the alarm is not unmasked forever.

Second System

According to a second system, each node has a timer. FIG. 5 shows a path setup sequence using the second system. As in the case of FIG. 4, each node starts masking the path alarm in response to the path connection by the path message or the reservation message as a trigger (steps S23 through S25).

According to the second system, a timer is started at the time of starting masking in each node, and the UNEQ-P alarm is unmasked when the timer reaches a predetermined time.

In FIG. 5, each of two-dot chain lines 11, 13, and 15 indicates the period from when the path connection is established and the masking is started to when the timer reaches a predetermined time so that the masking is canceled. Further, each of dotted lines 12, 14, and 16 indicates the period for which the UNEQ-P alarm is generated. In FIG. 5, in Node B, the masking of the UNEQ-P alarm is started (the starting point of the line 11 indicating the progress of time in the downward direction) when the connection of its input-side port B-4 and the output-side port B-1 is completed after receiving the reservation message of step S25, and the masking is turned OFF after passage of a predetermined time (at time X: the end point of the line 11).

However, although the UNEQ-P alarm is cleared at time Y (the end point of the line 12) in Node B, the masking continues from time Y to time X. That is, after time Y, masking is performed although it should not be performed. The same problem occurs in Node C.

In Node D, the masking is turned OFF at time X because the timer reaches the predetermined time, and the UNEQ-P alarm due to incompletion of the entire path is detected and output from time X to time Y. However, the UNEQ-P alarm output during this period should be masked.

Thus, according to the second system, there is a problem in that the UNEQ-P alarm is masked although it should not be masked or the UNEQ-P alarm is unmasked although it should be masked. In order to reduce this problem, an appropriate timer time may be set in each node. It is difficult, however, to appropriately set the timer so as to reduce the above-described problem because the time up to completion of the path setup changes depending on the configuration or condition of the network.

Third System

The first system and the second system may be combined as illustrated in FIG. 6. In the case of FIG. 6, Node B supports the same unmasking function using a timer as in the second system, and also supports the function of canceling masking by canceling the timer in response to reception of the reservation confirmation message as a trigger. Node C supports the unmasking function using a timer. Node D supports the function of canceling masking in response to reception of the reservation confirmation message as a trigger.

In FIG. 6, each of one-dot chain lines 17 and 22 indicates the period for which masking is performed. Further, each of dotted lines 19, 21, and 23 indicates the period for which the UNEQ-P alarm is generated. Further, each of two-dot chain lines 18 and 20 indicates the period from when the masking is started to when the timer reaches a predetermined time.

For example, the masking is canceled at time X in response to reception of the reservation confirmation message as a trigger in Node B supporting the reservation confirmation message. However, the same problem as in the second system occurs in Node C, which does not support the reservation confirmation message. Further, the masking may not be canceled forever in Node D, which supports the reservation confirmation message but does not receive the reservation confirmation message. Further, even in the case where the reservation confirmation message is received by a node that supports both unmasking using reception of the reservation confirmation message as a trigger and unmasking with a timer, the masking may be canceled by the timer before the node receives the reservation confirmation message depending on the size of the network. In this case, there remains the problem of inability to mask the alarm that should be masked.

### SUMMARY

Embodiments of the present invention may solve or reduce one or more of the above-described problems.

According to an aspect of an embodiment, a transmission apparatus and an alarm control method are provided in which one or more of the above-described problems may be solved or reduced.

According to an aspect of an embodiment, a transmission apparatus and an alarm control method are provided that make it possible to mask a specific alarm generated during a path setup operation and cancel the alarm with appropriate timing.

According to an aspect of an embodiment, a transmission apparatus having a function of establishing a connection of a path that is a signal communications channel in a communications network is provided that includes a masking part configured to mask an alarm detected after the connection of the path is established in the transmission apparatus; an alarm status detection part configured to detect a change in a status of the alarm; and an unmasking part configured to unmask the alarm masked by the masking part in response to the alarm status detection part detecting the change in the status of the alarm.

According to an aspect of an embodiment, there is provided an alarm control method including the steps of (a) masking an alarm detected after a connection of a path is established in a transmission apparatus, the path being a signal communications channel in a communications network; and (b) unmasking the alarm masked by said step (a) in response to detecting a change in a status of the alarm in the transmission apparatus.

According to an aspect of an embodiment, it is possible to provide a transmission apparatus and an alarm control method that make it possible to mask a specific alarm generated during a path setup operation and cancel the alarm with appropriate timing.

### BRIEF DESCRIPTION OF THE DRAWINGS

Other objects, features and advantages of the present invention will become more apparent from the following detailed description when read in conjunction with the accompanying drawings, in which:

FIG. 1 is a diagram showing a signaling sequence for a path setup in a communications network;

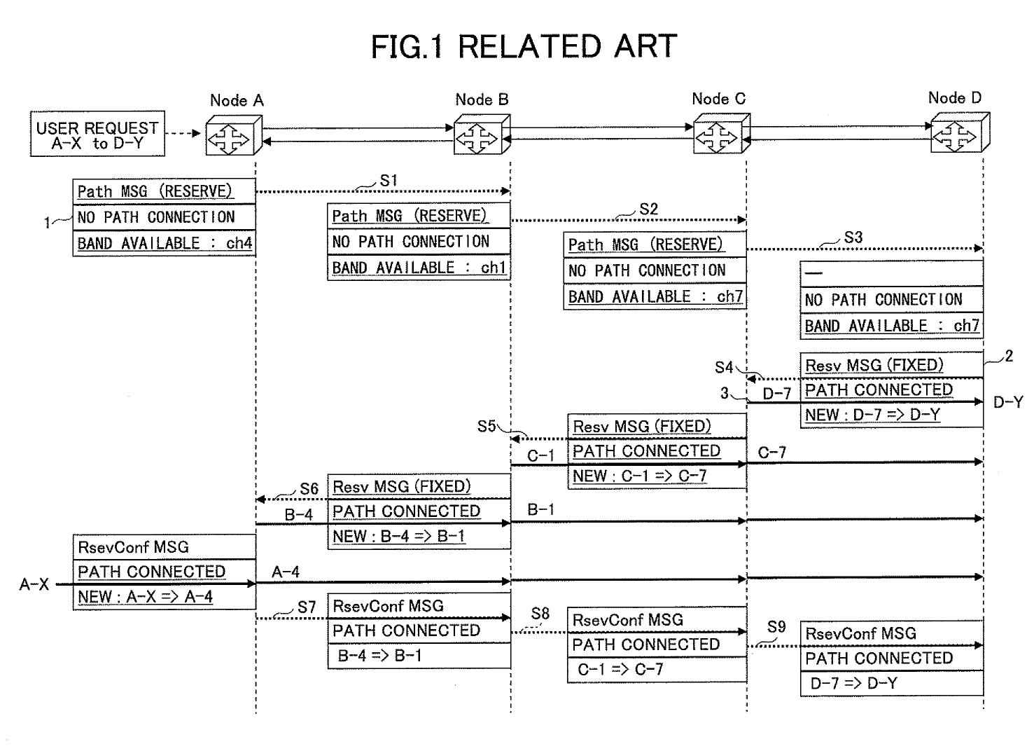

FIG. 2 is a diagram for illustrating a system of issuing a UNEQ-P alarm;

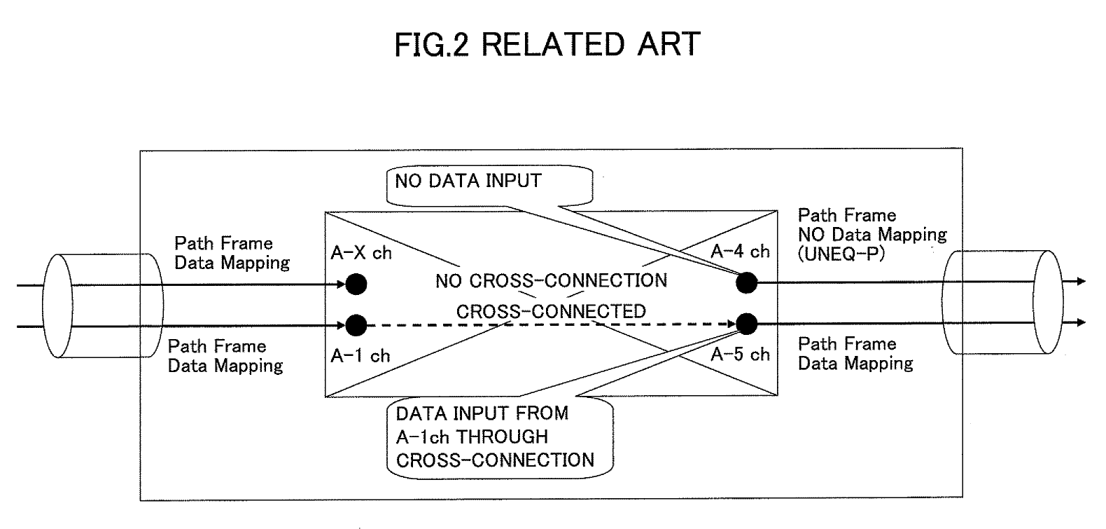

FIG. 3 is a diagram for illustrating a system of detecting the UNEQ-P alarm;

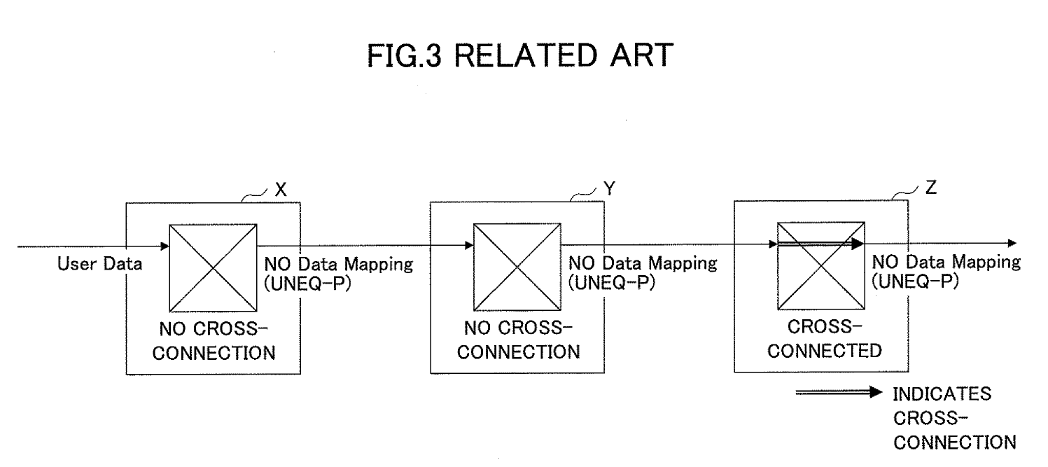

FIG. 4 is a diagram for illustrating a system of canceling masking using a reservation confirmation message;

FIG. 5 is a diagram for illustrating a system of canceling masking using a timer;

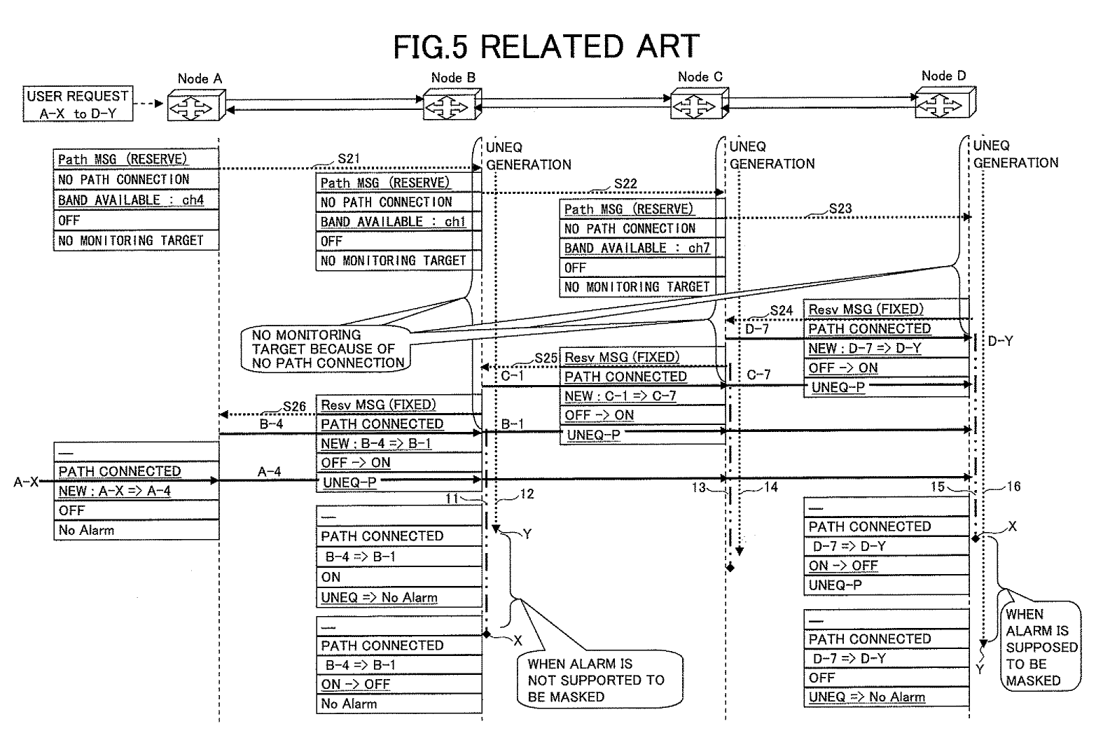

FIG. 6 is a diagram for illustrating a system combining a first system and a second system;

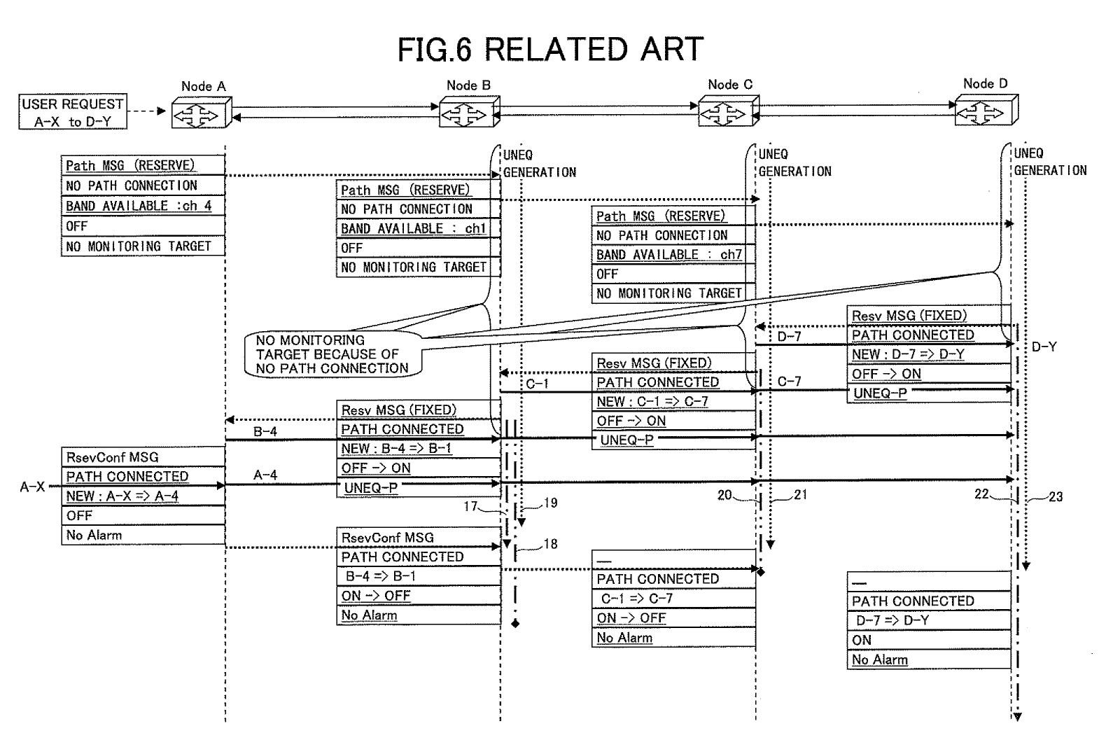

FIG. 7 is a diagram showing a configuration of a transmission apparatus according to an embodiment of the present invention;

FIG. 8 is a diagram showing a path setup sequence in a network having Nodes A through D according to the embodiment of the present invention;

FIG. 9 is a diagram for illustrating operations of start Node A according to the embodiment of the present invention;

FIG. 10 is a diagram for illustrating operations of intervening Nodes B and C according to the embodiment of the present invention;

FIG. 11 is a diagram for illustrating operations of terminal Node D according to the embodiment of the present invention;

FIG. 12 is a diagram for illustrating a case where the UNEQ-P alarm changes to another alarm according to the embodiment of the present invention;

FIG. 13 is a flowchart showing operations of the transmission apparatus according to the embodiment of the present invention;

FIG. 14 shows an alarm management table according to the embodiment of the present invention;

FIG. 15 shows an example of the alarm management table in the case where a single kind of alarm is to be masked according to the embodiment of the present invention;

FIG. 16 shows an example of the alarm monitoring table 200 in the case where multiple kinds of alarms are to be masked according to the embodiment of the present invention; and

FIG. 17 is a diagram for illustrating a status change in the transmission apparatus according to the embodiment of the present invention.

### DETAILED DESCRIPTION OF THE PREFERRED EMBODIMENTS

A description is given below, with reference to the accompanying drawings, of an embodiment of the present invention.

(Apparatus Configuration)

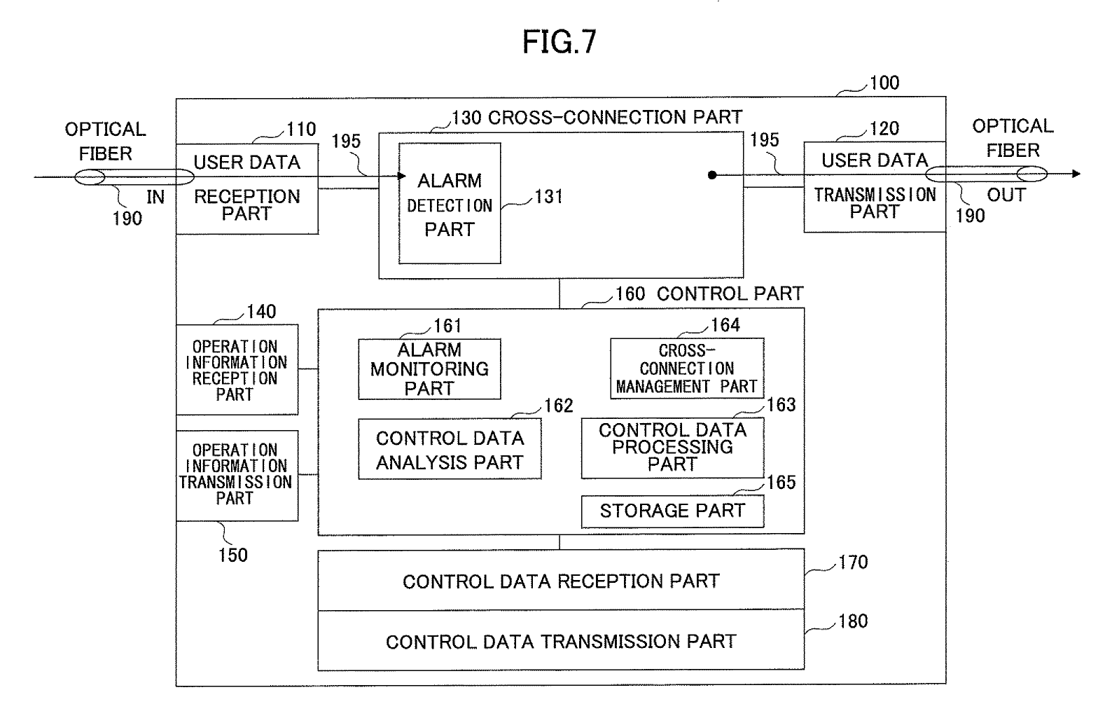

FIG. 7 is a diagram showing a configuration of a transmission apparatus 100 according to the embodiment of the present invention.

The transmission apparatus 100 forms each node in a network in which a path is set up. In this embodiment, a description is given, taking the transmission apparatus 100 supporting a GMPLS network as an example. However, the present invention may be applied not only to GMPLS but also to other protocols.

Referring to FIG. 7, the transmission apparatus 100 of this embodiment includes a user data reception part 110 configured to receive user data; a user data transmission part 120 configured to transmit the user data; a cross-connection part 130 configured to cross-connect the user data; an operation information reception part 140 configured to receive a user's request; an operation information transmission part 150 configured to transmit a response to the user's request to the outside; a control part 160 configured to execute control processing for a path setup by RSVP signaling; a control data reception part 170 configured to receive control data for the path setup by RSVP signaling; and a control data transmission part 180 configured to transmit the control data for the path setup by RSVP signaling.

The cross-connection part 130 includes an alarm detection part 131 configured to detect an alarm from a received signal. The control part 160 includes an alarm monitoring part 161 configured to monitor the alarm detected in the alarm detection part 131; a control data analysis part 162 configured to analyze the control data; a control data processing part 163 configured to make a query about an available band and a request for setting up a cross-connection based on the control data (a GMPLS path message according to this embodiment); and a cross-connection management part 164 configured to set up a cross-connection for the cross-connection part 130 and make a request for alarm monitoring to the alarm monitoring part 161. Further, the transmission apparatus 100 has physical input/output channels 190 such as optical fibers, and the user data are input to and output from the transmission apparatus through input/output channels 195.

(Operations of Transmission Apparatus)

Next, a description is given of a path setup operation in the network where transmission apparatuses having the above-described configuration are disposed as nodes.

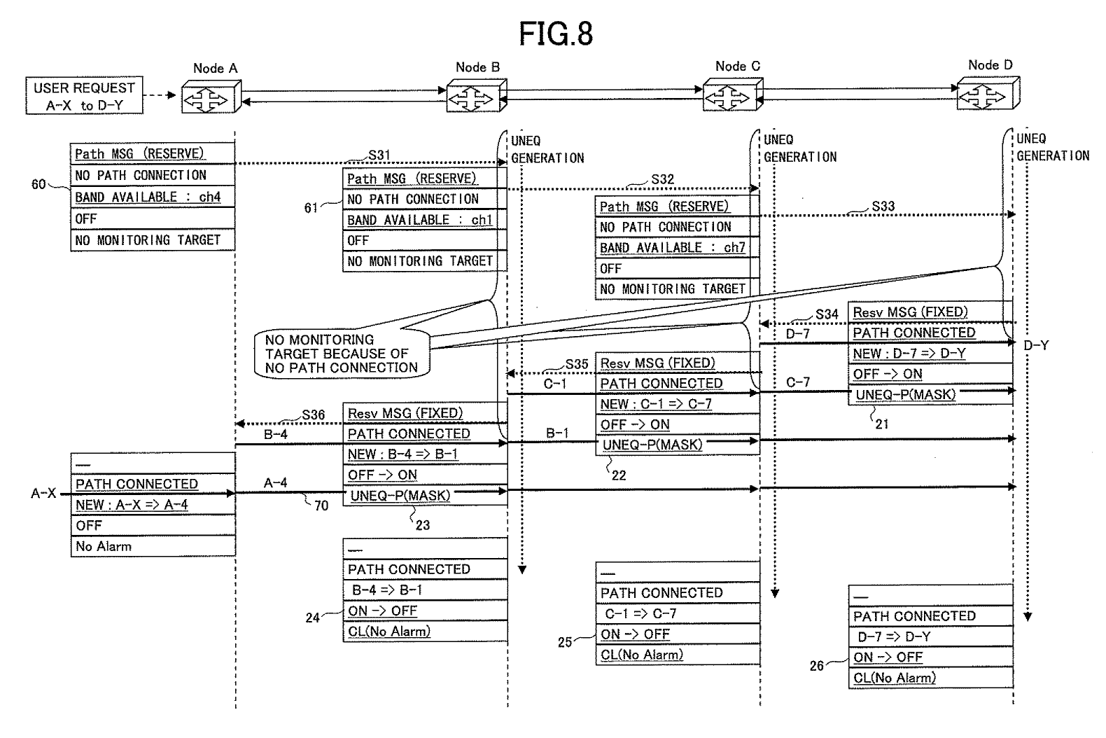

FIG. 8 shows an operational sequence of a path setup in a network having Nodes A, B, C, and D.

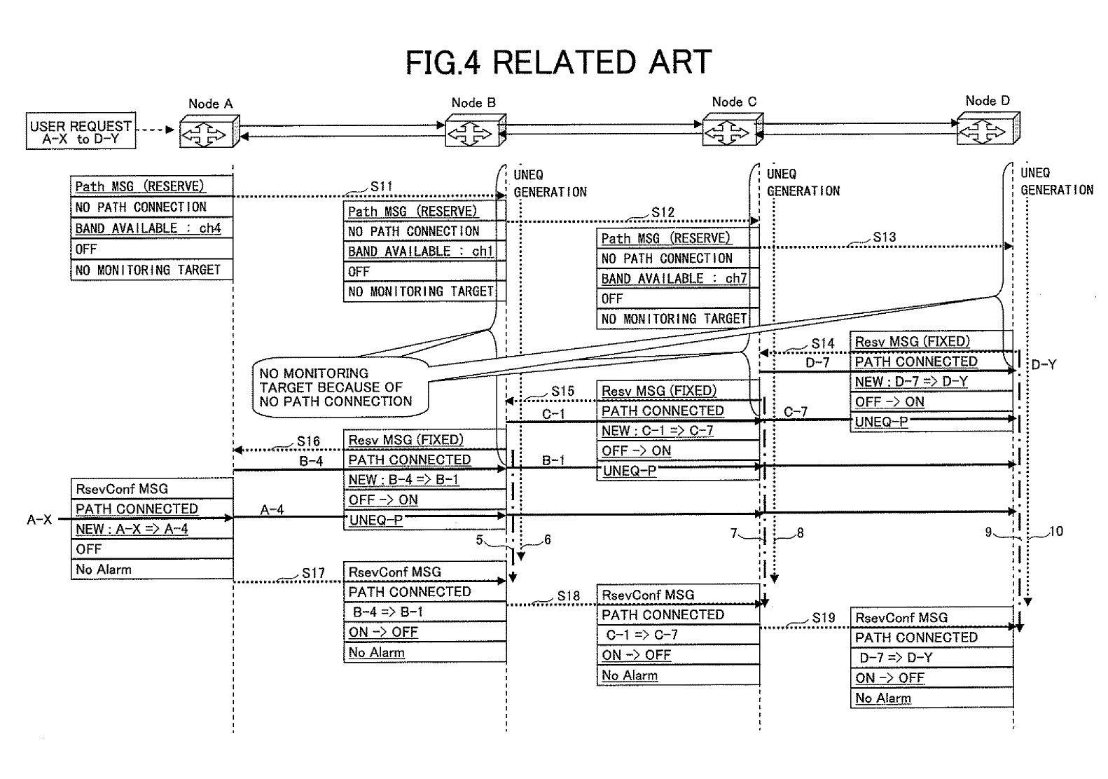

Each of Nodes A through D is a transmission apparatus having the same configuration of the transmission apparatus 100 according to the embodiment of the present invention. A description is given of processing operations according to this embodiment in line with the operational sequence of FIG. 8 while describing the internal operations of each of a start node (Node A), intervening (intermediate) nodes (Node B and Node C), and a terminal node (Node D). In FIG. 8, each of rectangular frames including rectangular frames 60, 61, 21, 22, 23, 24, 25, and 26 shows the same information items as those described in FIG. 4.

Reception of Path Setup Request

First, in step S31 of FIG. 8, Node A receives a path setup request. This path setup request is a message that requests to set up a path from the input-side port A-X of Node A to the output-side port D-Y of Node D.

(B) Operations of Node A Having Received Path Setup Request

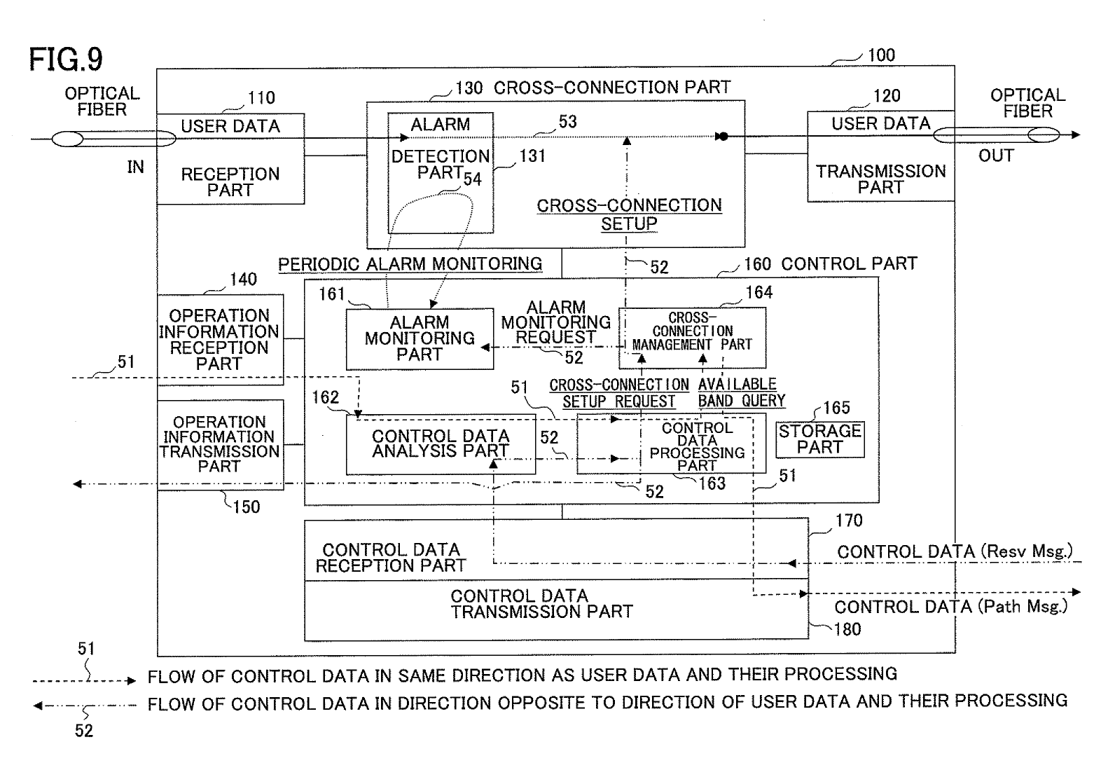

FIG. 9 is a diagram for illustrating operations of Node A, which is a start node. In FIG. 9, a broken line 51 indicates a flow of processing based on control data (an RSVP message according to this embodiment) in the same direction as user data. Further, a two-dot chain line 52 indicates a flow of processing based on control data in a direction opposite to that of the user data. Further, a dotted line 53 indicates the actual connection of a path in the transmission apparatus, and a dotted line 54 indicates periodic alarm monitoring.

In Node A that has received the path setup request, processing is performed along the line 51 in FIG. 9. As illustrated in FIG. 9, the operation information reception part 140 receives the path setup request. Then, the control data analysis part 162 analyzes the path setup request to figure out a starting-point port, a terminal port, and the band of a requested path from the path setup request, and passes the results of the analysis to the control data processing part 163.

The control data processing part 163 queries the cross-connection management part 164 as to the availability of a necessary band in Node A, and if there is an available band, the control data processing part 163 reserves the band. In this embodiment, the No. 4 output-side port of Node A is reserved as a port corresponding to the band as indicated in the rectangular frame 60 in FIG. 8.

Thereafter, an RSVP path message is transmitted from the control data transmission part 180 of FIG. 9 to intervening Node B. If a necessary band is not available, error processing is performed.

(C) Processing in Nodes B and C Having Received Path Message

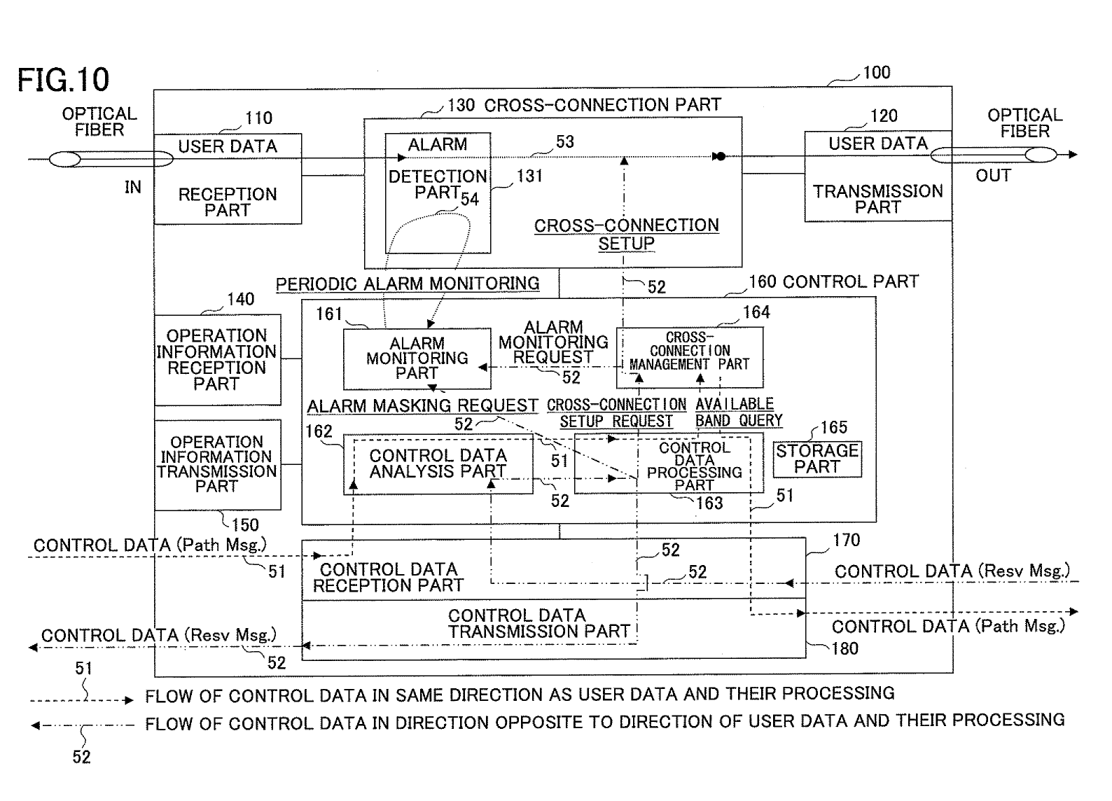

FIG. 10 is a diagram for illustrating operations of intervening Node B.

In FIG. 10 also, the line 51 indicates a flow of processing based on the control data in the same direction as the user data, the line 52 indicates a flow of processing based on the control data in the direction opposite to that of the user data, the line 53 indicates the actual connection of a path in the transmission apparatus, and the line 54 indicates periodic alarm monitoring.

In Node B that has received the path message indicated by step S31 in FIG. 8, processing is performed along the line 51 in FIG. 10. The same processing as the processing in Node B described herein is performed in Node C, which is another intervening node, when Node C receives a path message.

As illustrated in FIG. 10, the control data reception part 170 receives the path message, and the control data analysis part 162 analyzes the band of the requested path based on the path message and passes the results of the analysis to the control data processing part 163. The control data processing part 163 queries the cross-connection management part 164 as to the availability of a necessary band in Node B, and if there is an available band, the control data processing part 163 reserves the band. In this embodiment, the No. 1 output-side port of Node B is reserved as a port corresponding to the band as indicated in the rectangular frame 61 in FIG. 8. A No. 7 output-side port is reserved in Node C.

Next, the control data transmission part 180 of FIG. 10 transmits a path message to Node C. In the case of Node C, a path message is transmitted to terminal Node D.

(D) Processing in Node D Having Received Path Message

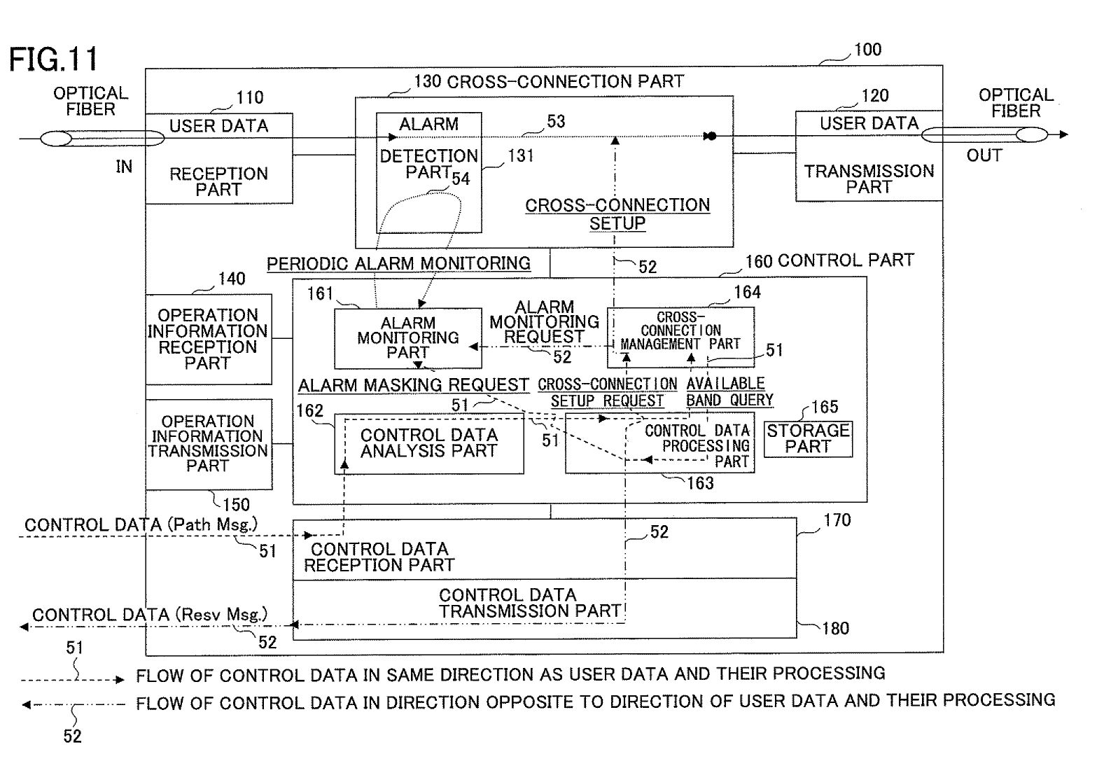

FIG. 11 is a diagram for illustrating operations of Node D, which is a terminal node.

In FIG. 11 also, the line 51 indicates a flow of processing based on the control data in the same direction as the user data, the line 52 indicates a flow of processing based on the control data in the direction opposite to that of the user data, the line 53 indicates the actual connection of a path in the transmission apparatus, and the line 54 indicates periodic alarm monitoring.

In Node D that has received the path message indicated by step S33 in FIG. 8, processing is performed along the line 51 in FIG. 11 except for processing with respect to transmission of a reservation message, which is performed along the line 52. The control data reception part 170 receives the path message, and the control data analysis part 162 analyzes the path message to figure out the output-side port and the band of the requested path from the path message, and passes the results of the analysis to the control data processing part 163.

The control data processing part 163 queries the cross-connection management part 164 as to the availability of a necessary band in Node D. If there is an available band, the control data processing part 163 makes a cross-connection setup request to the cross-connection management part 164.

Further, the control data processing part 163 requests the alarm monitoring part 161 to mask a UNEQ-P alarm. In response to reception of the cross-connection setup request, the cross-connection management part 164 sets up a cross-connection, and further requests the alarm monitoring part 161 to monitor a setup-related path alarm. In response to reception of the path alarm monitoring request and the UNEQ-P alarm masking request, the alarm monitoring part 161 starts monitoring an alarm and masking the UNEQ-P alarm.

Then, the alarm monitoring part 161 continues masking until the UNEQ-P alarm is cleared or changes to another alarm (that is, the state transition of the UNEQ-P alarm occurs). That is, even when the alarm monitoring part 161 senses (determines) that the UNEQ-P alarm has been detected in the alarm detection part 131, the alarm monitoring part 161 does not report the detection of the UNEQ-P alarm to the outside through the operation information transmission part 150 while the masking continues.

After making the cross-connection setup request to the cross-connection management part 164 and making the UNEQ-P alarm masking request to the alarm monitoring part 161, the control data processing part 163 transmits a reservation message from the control data transmission part 180 to Node C. This reservation message is indicated by step S34 in FIG. 8.

At the time of path connecting in terminal Node D, no path has been set up in Nodes A through C because of the nature of RSVP signaling. Therefore, the UNEQ-P alarm of the path is detected in the alarm detection part 131 of Node D. However, even when the alarm monitoring part 161 senses (determines) that the UNEQ-P alarm has been detected in the alarm detection part 131, the UNEQ-P alarm is masked and prevented from being output to the outside.

In this embodiment, the alarm to be masked is the UNEQ-P alarm. Alternatively, however, a different (kind of) alarm or multiple (kinds of) alarms may be subjected to masking in other forms of the network such as WDM. Further, a user may select the type of an alarm to be masked.

The rectangular frame 21 in FIG. 8 shows the status at the time of the start of masking in Node D.

(E) Processing in Intervening Nodes C and B Having Received Reservation Message

A description is given, with reference to FIG. 10, of operations of Node C that has received the reservation message indicated by step S34 in FIG. 8. The same processing as the processing in Node C described herein is also performed in Node B when Node B receives a reservation message.

In intervening Node C that has received the reservation message indicated by step S34 in FIG. 8, processing is performed along the line 52 in FIG. 10.

The control data reception part 170 in Node C receives the reservation message from Node D. Then, the control data analysis part 162 analyzes the reservation message to figure out the ports and the band of the path determined from the reservation message, and passes the results of the analysis to the control data processing part 163. The control data processing part 163 makes a cross-connection setup request to the cross-connection management part 164, and requests the alarm monitoring part 161 to mask a setup-related path UNEQ-P alarm.

In response to reception of the cross-connection setup request, the cross-connection management part 164 sets up a cross-connection, and further requests the alarm monitoring part 161 to perform alarm monitoring of the path. In response to reception of the path alarm monitoring request and the UNEQ-P alarm masking request, the alarm monitoring part 161 starts monitoring a path alarm and masking the UNEQ-P alarm. The alarm monitoring part 161 continues masking until the UNEQ-P alarm is cleared or changes to another alarm (that is, the state transition of the UNEQ-P alarm occurs).

After making the cross-connection setup request to the cross-connection management part 164 and making the UNEQ-P alarm masking request to the alarm monitoring part 161, the control data processing part 163 transmits a reservation message from the control data transmission part 180 to Node B. In the case of Node B, the reservation message is transmitted to Node A. These reservation messages are indicated by steps S35 and S36, respectively, in FIG. 8.

At the time of pass connecting in Nodes C and B, the path setup has not been completed the same as in the case of Node D. Accordingly, the UNEQ-P alarm is detected in each of Nodes C and B. However, since the UNEQ-P alarm is masked, the UNEQ-P alarm is not output outside. The rectangular frames 22 and 23 in FIG. 8 indicate the statuses at the time of the start of masking in Nodes C and B, respectively.

(F) Processing in Start Node A Having Received Reservation Message

A description is given, with reference to FIG. 9, of operations in Node A that has received the reservation message indicated by step S36 in FIG. 8. In Node A that has received the reservation message indicated by step S36 in FIG. 8, processing is performed mainly along the line 52 in FIG. 9.

When the control data reception part 170 of Node A receives the reservation message, the control data analysis part 162 analyzes the reservation message to figure out the ports and the band of the path determined from the reservation message, and passes the results of the analysis to the control data processing part 163. The control data processing part 163 makes a cross-connection setup request to the cross-connection management part 164. In response to reception of the cross-connection setup request, the cross-connection management part 164 sets up a cross-connection, and further requests the alarm monitoring part 161 to perform alarm monitoring of the path.

In response to reception of the path alarm monitoring request, the alarm monitoring part 161 starts monitoring a path alarm. Since Node A is a start node, Node A is not preceded by a node that requires path connection. Accordingly, user data are received by the path connection in Node A, so that no UNEQ-P alarm is detected. Therefore, there is no need for masking in Node A.

(G) Unmasking UNEQ-P Alarm in Intervening Nodes B and C and Terminal Node D

As indicated by a bold solid line 70 in FIG. 8, when the cross-connection is completed in Node A, a signal input to the port A-X of Node A flows through the channel of A-X→A-4→B-4→B-1→C-1→C-7→D-7→D-Y.

Therefore, the UNEQ-P alarms generated in Nodes B, C, and D are canceled. The operations of Node B at this point are as follows. The same operations as those of Node B are also performed in Node C and Node D.

When the alarm monitoring part 161 detects the clearance of the UNEQ-P alarm or a change of the UNEQ-P alarm to another alarm such as an alarm indication signal (AIS), the alarm monitoring part 161 checks whether the UNEQ-P alarm is being masked with respect to the target path. In this case, since the UNEQ-P alarm is being masked, the alarm monitoring part 161 determines that the path setup has been completed through the entire network, unmasks the UNEQ-P alarm, and returns to a normal operating mode (a normal alarm monitoring mode) (rectangular frames 24 through 26).

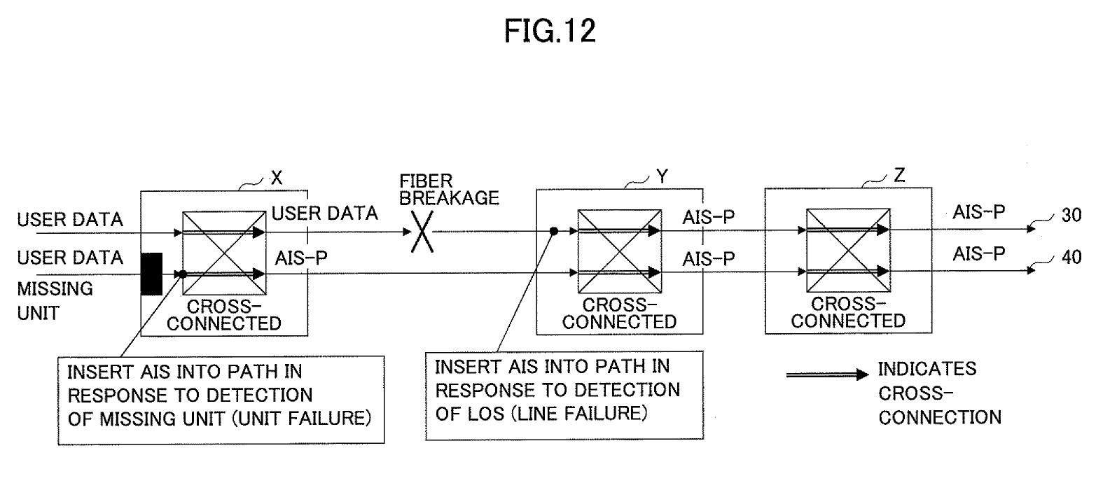

FIG. 12 shows a case where the UNEQ-P alarm changes to another alarm. In the case of FIG. 12, the UNEQ-P alarm changes to an AIS-P alarm. FIG. 12 shows two paths (an upper path 30 and a lower path 40) passing through Nodes X, Y, and Z. FIG. 12 also shows that there is a fiber breakage between Node X and Node Y in the path 30 and that a unit is missing in Node X in the path 40.

With respect to the path 30, when the path connection is completed in Node Z while the path connection is incomplete in Node Y, the UNEQ-P alarm is detected in Node Z. When the path connection in Node Y and the path connection in Node Z are completed and if there is no particular failure, the UNEQ-P alarm is cleared so that masking is canceled. However, if there is a fiber breakage as illustrated in FIG. 12, user data are prevented from flowing to Node Y and Node Z. Instead, an AIS-P alarm is inserted into the path 30 at Node Y in response to detection of LOS (line failure), and flows to Node Z. In this case, the change from the UNEQ-P alarm to the AIS-P alarm is detected so that the masking is canceled in Node Z.

With respect to the path 40, user data are prevented from flowing downstream by the failure of a missing unit in Node X. Instead, an AIS-P alarm is inserted into the path 40 in response to detection of the unit failure (missing unit) and flows so that a change in the status of the UNEQ-P alarm is detected. As a result, masking can be canceled.

(Operations of Transmission Apparatus Regarding Cancellation of Specific Alarm)

In the above-described example, a description is given of the case where the alarm to be masked is the UNEQ-P alarm by way of example. In other forms of the network, however, the alarm to be masked may be different or multiple alarms may have to be masked. Further, the transmission apparatus 100 may be configured to cause a user to select the alarm to be masked.

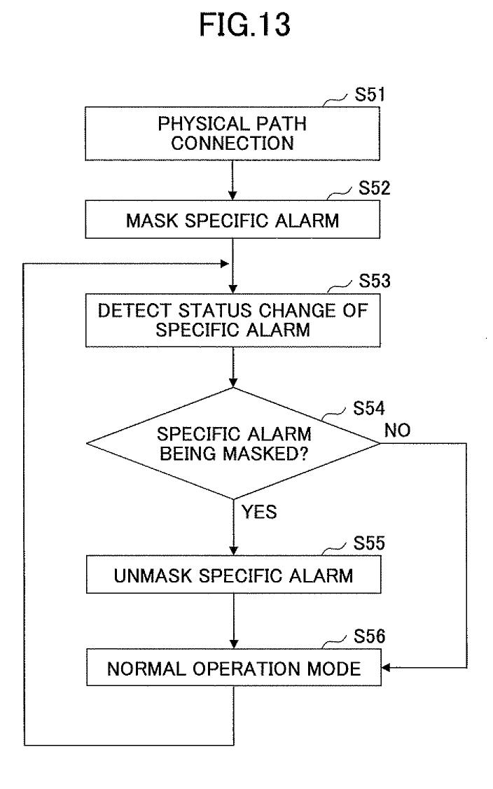

Next, a description is given, with reference to the flowchart of FIG. 13, of general operations of the transmission apparatus 100 regarding cancellation of an alarm according to this embodiment, which alarm may be, but is not limited to, the UNEQ-P alarm.

Referring to FIG. 13, in step S51, the cross-connection part 130 establishes a physical path connection in response to reception of a reservation message. Then, in step S52, in response to reception of requests from the cross-connection management part 164 and the control data processing part 163, the alarm monitoring part 161 starts monitoring an alarm and starts masking a specific alarm to be masked (for example, the UNEQ-P alarm). In more detail, the alarm monitoring part 161 performs masking immediately after the alarm monitoring part 161 senses (determines) that the alarm detection part 131 has detected a specific alarm related to the masking request from the control data processing part 163.

The alarm monitoring part 161 monitors an alarm by periodically checking the alarm detection part 131. Alternatively, the alarm monitoring part 161 may monitor an alarm by receiving a message transmitted from the alarm detection part 131 or through an interruption by the alarm detection part 131.

In step S53, the alarm monitoring part 161 detects a change in the status of the specific alarm, such as the clearance of the specific alarm or a change of the specific alarm to another alarm. Then, in step S54, the alarm monitoring part 161 checks (determines) whether the specific alarm is being masked with respect to the target path. If it is determined in step S54 that the specific alarm is being masked, in step S55, the alarm monitoring part 161 determines that a physical path setup has been completed through the entire network, and cancels the masking. Then, in step S56, the alarm monitoring part 161 returns to a normal operating mode. In general, in the normal operating mode, the specific alarm is not being masked when a change in the status of the specific alarm is detected.

If the alarm monitoring part 161 determines in step S54 of FIG. 13 that the specific alarm is not being masked, in step S56, the alarm monitoring part 161 maintains the normal operating mode.

That is, the transmission apparatus 100 includes a masking part configured to mask a specific alarm detected after establishing a path connection; an alarm status detection part configured to detect a change in the status of the specific alarm; and an unmasking part configured to unmask the specific alarm masked by the masking part in response to the alarm status detection part detecting the change in the status of the specific alarm. In this case, the masking part may correspond to the alarm monitoring part 161 and the control data processing part 163, the alarm status detection part may correspond to the alarm detection part 131 and the alarm monitoring part 161, and the unmasking part may correspond to the alarm monitoring part 161.

(Detailed Operations of Masking in Transmission Apparatus)

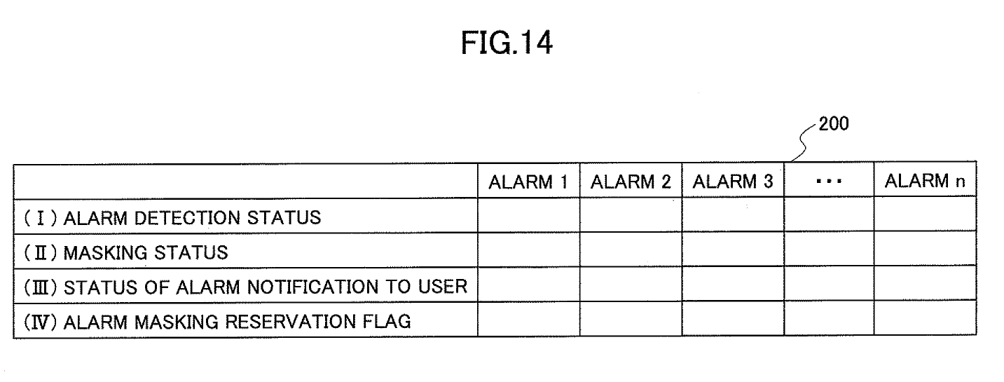

Next, a description is given in more detail of masking in the transmission apparatus 100. The control part 160 in the transmission apparatus 100 according to this embodiment contains the data of as many alarm management tables as illustrated in FIG. 14 as the number of paths supported by the transmission apparatus 100 in a storage part 165 (FIG. 7).

Referring to FIG. 14, an alarm management table 200 contains information on the alarm detection status (raw alarm status), the masking status, the status of alarm notification to a user, and an alarm masking reservation flag for each alarm.

In response to a request from the control data processing part 163 to mask a specific alarm, the alarm monitoring part 161 turns ON the alarm masking reservation flag for the specific alarm. The time of turning ON the flag in response to the specific alarm masking request from the control data processing part 163 corresponds to the time of completion of establishing a path connection from where there is no path connection. Then, after the alarm masking reservation flag is turned ON, alarm monitoring is started, and the alarm monitoring part 161 sets the alarm detection status of the specific alarm of the alarm management table 200 of the path to “MONITORING STARTED.” If the specific alarm is generated, the alarm monitoring part 161 sets its alarm detection status to “GENERATED.” Further, if the specific alarm is cleared, the alarm monitoring part 161 sets its alarm detection status to “CLEARED.”

Further, when the alarm monitoring part 161 detects the specific alarm and its alarm masking reservation flag is ON, the alarm monitoring part masks the specific alarm, and sets its masking status to “MASKED.” The alarm monitoring part 161 turns the alarm mask reservation flag OFF in response to masking the specific alarm. Further, in the case of outputting the alarm in response to its detection, the alarm monitoring part 161 sets the status of alarm notification to a user with respect to the alarm to “GENERATION REPORTED.” In the case of notifying the user of the clearance of the alarm, the alarm monitoring part 161 sets the status of alarm notification to a user to “CLEARANCE REPORTED.” The alarm monitoring part 161 cancels masking in response to recognizing the clearance of the specific alarm.

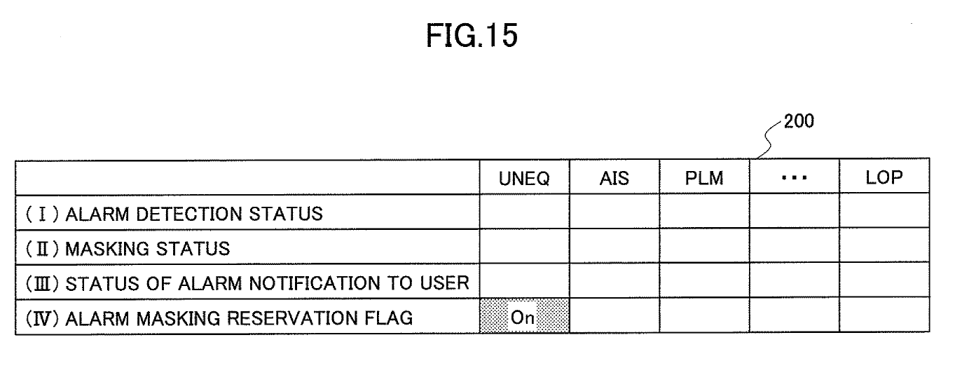

FIG. 15 shows an example of the alarm monitoring table 200 in the case where a single kind of alarm is to be masked during construction of a network. FIG. 15 shows the case where the transmission apparatus 100 is, for example, a SONET apparatus and the specific alarm during construction of a network is the UNEQ-P alarm. Further, in the case illustrated in FIG. 15, the path connection is completed and the alarm masking reservation flag is ON.

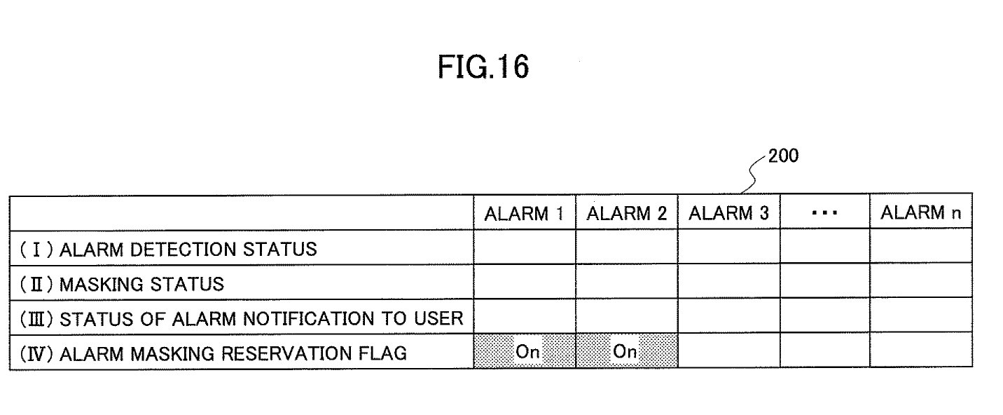

FIG. 16 shows an example of the alarm monitoring table 200 in the case where multiple kinds of alarms are to be masked during construction of a network. FIG. 16 shows the case where the path connection is completed and the alarm masking reservation flag is ON for each of ALARM 1 and ALARM 2. In FIG. 14 through FIG. 16, the alarm to be managed by the alarm management table 200 may be limited to a specific alarm to be masked.

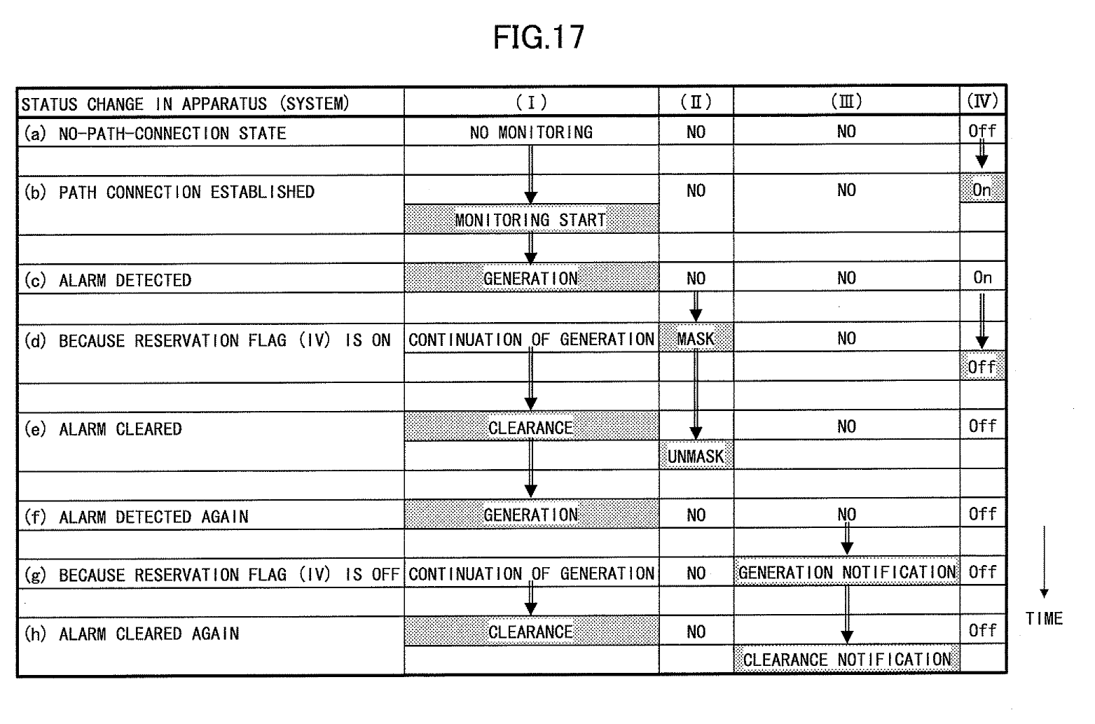

Next, a description is given, with reference to FIG. 17, of a status change in the transmission apparatus 100. In FIG. 17, time progresses from top to bottom, and the statuses (I), (II), (III), and (IV) corresponding to the statuses (I), (II), (III), and (IV), respectively, of the alarm management table 200 are horizontally shown.

With no path connection, no alarm is monitored and neither masking nor alarm notification is provided. Further, the alarm masking reservation flag is OFF.

In response to a request from the control data processing part 163 to mask a specific alarm, the alarm monitoring part 161 turns ON the alarm masking reservation flag for the specific alarm, and thereafter starts monitoring alarms including the specific alarm.

The alarm monitoring part 161 detects generation of the specific alarm.

Then, the alarm monitoring part 161 checks the ON/OFF status of the alarm masking reservation flag. If the flag is ON, the alarm monitoring part 161 starts masking the specific alarm. Further, after starting masking the specific alarm, the alarm monitoring part 161 turns OFF the alarm masking reservation flag for the specific alarm. If there are multiple specific alarms and multiple alarm masking reservation flags are ON for a path, all the flags that have been ON are turned OFF after any of the specific alarms is generated and the masking of the generated alarm is started.

The alarm monitoring part 161 unmasks the specific alarm in response to recognizing the clearance of the specific alarm (using the recognition as a trigger).

Thereafter, the alarm monitoring part 161 detects generation of the specific alarm of the path.

The alarm monitoring part 161 checks the ON/OFF status of the alarm masking reservation flag for the specific alarm. The alarm monitoring part 161 confirms the OFF status of the flag, and reports the generation of the specific alarm to the outside without performing masking.

Further, when the specific alarm is cleared, the alarm monitoring part 161 transmits an alarm clearance notification to the user.

As described above, according to the transmission apparatus 100 of this embodiment, masking of the UNEQ-P alarm is started in setting up a path, and the masking is canceled in response to the clearance (no alarm state) or transition to another alarm such as Path AIS of the UNEQ-P alarm of the path during the masking of the UNEQ-P alarm. According to this system, the status change of the alarm to be subjected to masking cancellation is used as a trigger for the masking cancellation, and a specific message (such as a reservation confirmation message) from an opposing apparatus is not used. Therefore, the transmission apparatus 100 is capable of canceling the masking at an appropriate time without being affected by the design of the opposing apparatus or the supporting conditions of the specific message. Further, the problem of the system using a timer is also eliminated.

That is, according to this embodiment, in network construction using E-NNI signaling based on GMPLS, it is possible to achieve masking (start and cancellation) processing of an optimum period without dependence on the presence or absence of support for the specific message or network size.

Further, the transmission apparatus 100 according to this embodiment cancels masking by monitoring a change in the status of a specific alarm. Therefore, it is possible to achieve masking (start and cancellation) processing of an optimum period without dependence on the path setup method. For example, even in the case of performing path connecting by a user externally inputting a command to the transmission apparatus 100, the transmission apparatus 100 turns ON the flag in response to the path connection, starts monitoring an alarm, performs masking, and cancels the masking when detecting a change in the status of the alarm through the same operations as those (FIG. 17, etc.) described in this embodiment.

Thus, according to one aspect of the present invention, it is possible to provide a transmission apparatus and an alarm control method that make it possible to mask a specific alarm generated during a path setup operation and cancel the alarm with appropriate timing.

The present invention is not limited to the specifically disclosed embodiment, and variations and modifications may be made without departing from the scope of the present invention.

What is claimed is:

1. A transmission apparatus having a function of establishing a connection of a path, the path being a signal communications channel in a communications network, the transmission apparatus comprising:
a masking part configured to mask an alarm detected after the connection of the path is established in the transmission apparatus;
an alarm status detection part configured to detect a change in a status of the alarm; and
an unmasking part configured to unmask the alarm masked by the masking part in response to the alarm status detection part detecting the change in the status of the alarm.

2. The transmission apparatus as claimed in claim 1, wherein the alarm indicates an absence of a transmission of user data on the path.

3. The transmission apparatus as claimed in claim 1, wherein the connection of the path is established in the transmission apparatus in response to receiving a predetermined signaling message for setting up the path from an external transmission apparatus.

4. The transmission apparatus as claimed in claim 1, wherein the connection of the path is established in the transmission apparatus based on a user's operation from outside the transmission apparatus.

5. The transmission apparatus as claimed in claim 1, further comprising:
a storage part configured to store an alarm masking reservation flag indicating a masking reservation status of the alarm,
wherein the alarm masking reservation flag is caused to indicate a presence of a reservation for masking the alarm, in response to the establishment of the connection of the path in the transmission apparatus, and thereafter, the alarm is masked and the alarm masking reservation flag is caused to indicate an absence of the reservation, in response to a detection of the alarm with the alarm masking reservation flag indicating the presence of the reservation.

6. An alarm control method, comprising the steps of:
(a) masking an alarm detected after a connection of a path is established in a transmission apparatus, the path being a signal communications channel in a communications network; and
(b) unmasking the alarm masked by said step (a) in response to detecting a change in a status of the alarm in the transmission apparatus.

7. The alarm control method as claimed in claim 6, wherein the alarm indicates an absence of a transmission of user data on the path.

8. The alarm control method as claimed in claim 6, wherein the connection of the path is established in the transmission apparatus in response to the transmission apparatus receiving a predetermined signaling message for setting up the path from an external transmission apparatus.

9. The alarm control method as claimed in claim 6, wherein the connection of the path is established in the transmission apparatus based on a user's operation from outside the transmission apparatus.

10. The alarm control method as claimed in claim 6, wherein:
the transmission apparatus includes a storage part configured to store an alarm masking reservation flag indicating a masking reservation status of the alarm, and
the alarm masking reservation flag is caused to indicate a presence of a reservation for masking the alarm, in response to the establishment of the connection of the path in the transmission apparatus, and thereafter, the alarm is masked and the alarm masking reservation flag is caused to indicate an absence of the reservation, in response to a detection of the alarm with the alarm masking reservation flag indicating the presence of the reservation.
